(19) United States
(12) Patent Application Publication
(10) Pub. No.: US 2008/0012569 A1
(43) Pub. Date: Jan. 17, 2008

(54) Downhole Coils

(76) Inventors: David R. Hall, Provo, UT (US); Craig Boswell, Provo, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 11/860,761

(22) Filed: Sep. 25, 2007

Related U.S. Application Data
(63) Continuation-in-part of application No. 11/739,344, filed on Apr. 24, 2007.
Application No. 11/739,344 is a continuation-in-part of application No. 11/421,387, filed on May 31, 2006.
Application No. 11/421,387 is a continuation-in-part of application No. 11/421,357, filed on May 31, 2006.
Application No. 11/421,357 is a continuation-in-part of application No. 11/133,905, filed on May 21, 2005, now Pat. No. 7,277,026.

(51) Int. Cl. H01R 4/24; F16L 55/00; H01R 11/00

(52) U.S. Cl. 324/367; 166/65.1; 285/9.1; 336/90; 439/39

(57) ABSTRACT

In one aspect of the invention, a downhole tool string component comprises a tubular body with at least one end adapted for threaded connection to an adjacent tool string component. The end comprises at least one shoulder adapted to abut an adjacent shoulder of an adjacent end of the adjacent tool string component. An annular magnetic coupler is disposed within an annular recess formed in the at least one shoulder, and the magnetic coupler comprises a coil in electrical communication with an electrical conductor that is in electrical communication with an electronic device secured to the tubular body. The coil comprises a plurality of windings of wire strands that are electrically isolated from one another and which are disposed in an annular trough of magnetic material secured within the annular recess.

### CROSS REFERENCE TO RELATED APPLICATIONS

This application is a continuation-in-part of U.S. application Ser. No. 11/739,344 filed on Apr. 24, 2007 and entitled “System and Method for Providing Electrical Power Downhole.” U.S. application Ser. No. 11/739,344 is a continuation in-part of U.S. application Ser. No. 11/421,387 filed on May 31, 2006 and entitled, “Wired Tool String Component.” U.S. application Ser. No. 11/421,387 is a continuation-in-part of U.S. application Ser. No. 11/421,357 filed on May 31, 2006 and entitled, “Wired Tool String Component.” U.S. application Ser. No. 11/421,357 is a continuation in-part of U.S. application Ser. No. 11/133,905 filed on May 21, 2005 and entitled, “Downhole Component with Multiple Transmission Elements.” All of these applications are herein incorporated by reference for all that they contain.

### BACKGROUND OF THE INVENTION

The present invention relates to downhole drilling, and more particularly, to systems and methods for transmitting power to components of a downhole tool string. Downhole sensors, tools, telemetry components and other electronic components continue to increase in both number and complexity in downhole drilling systems. Because these components require power to operate, the need for a reliable energy source to power these downhole components is becoming increasingly important. Constraints imposed by downhole tools and the harsh downhole environment significantly limit options for generating and providing power to downhole components.

Batteries provide one potential energy source to power downhole components. Batteries, however, may be hindered by their inherently finite life and the need for frequent replacement and/or recharging. This may be especially problematic in downhole drilling applications where access to batteries requires tripping and disassembly of the tool string. Battery function may also be impaired by extreme temperatures, pressures, or other conditions found downhole. Many types of batteries may be unable to reliably operate in downhole conditions. Furthermore, batteries may be required everywhere electronic equipment is located downhole, requiring large numbers of batteries and significant time for installation and replacement.

Another approach is to transmit power along the tool string using cables or other transmission media. For example, power may be generated at or near the ground's surface and then transmitted to various downhole components along the tool string. This approach, however, may also have its problems and limitations. Because a tool string may extend 20,000 feet or more into the ground, power transmitted along transmission lines may attenuate to an unacceptable level before it reaches its destination.

Attenuation may occur not only in transmission lines, but in components used to transmit power across tool joints of a tool string. Because a tool string may include many hundreds of sections of drill pipe and a roughly equal number of tool joints, a power signal may attenuate significantly after traveling a relatively short distance along the tool string. In view of the foregoing, what is needed is a system and method for reliably transmitting power to downhole sensors, tools, telemetry components and other electronic components in a downhole drilling system. Ideally, such a system and method would mitigate the problems with signal attenuation which may be present in some power transmission systems. A suitable system and method should also be able to provide reliable operation in extreme temperatures, pressures, and corrosive conditions encountered downhole.

As downhole instrumentation and tools have become increasingly more complex in their composition and versatile in their functionality, the need to transmit power and/or data through tubular tool string components is becoming ever more significant. Real-time logging tools located at a drill bit and/or throughout a tool string require power to operate. Providing power downhole is challenging, but if accomplished it may greatly increase the efficiency of drilling. Data collected by logging tools are even more valuable when they are received at the surface real time.

Many attempts have been made to provide high-speed data transfer or usable power transmission through tool string components. One technology developed involves using inductive couplers to transmit an electric signal across a tool joint. U.S. Pat. No. 2,414,719 to Cloud discloses an inductive coupler positioned within a downhole pipe to transmit a signal to an adjacent pipe.

U.S. Pat. No. 4,785,247 to Meador discloses an apparatus and method for measuring formation parameters by transmitting and receiving electromagnetic signals by antennas disposed in recesses in a tubular housing member and including apparatus for reducing the coupling of electrical noise into the system resulting from conducting elements located adjacent the recesses and housing.

U.S. Pat. No. 4,806,928 to Veneruso describes a downhole tool adapted to be coupled in a pipe string and positioned in a well that is provided with one or more electrical devices cooperatively arranged to receive power from surface power sources or to transmit and/or receive control or data signals from surface equipment. Inner and outer coil assemblies arranged on ferrite cores are arranged on the downhole tool and a suspension cable for electromagnetically coupling the electrical devices to the surface equipment is provided.

U.S. Pat. No. 6,670,880 to Hall also discloses the use of inductive couplers in tool joints to transmit data or power through a tool string. The '880 patent teaches of having the inductive couplers lying in magnetically insulating, electrically conducting troughs. The troughs conduct magnetic flux while preventing resultant eddy currents. U.S. Pat. No. 6,670,880 is herein incorporated by reference for all that it discloses.

U.S. patent application Ser. No. 11/133,905, also to Hall, discloses a tubular component in a downhole tool string with first and second inductive couplers in a frst end and third and fourth inductive couplers in a second end. A first conductive medium connects the first and third couplers and a second conductive medium connects the second and fourth couplers. The first and third couplers are independent of the second and fourth couplers. Application Ser. No. 11/133,905 is herein incorporated by reference for all that it discloses.

### BRIEF SUMMARY OF THE INVENTION

In one aspect of the invention, a downhole tool string component comprises a tubular body with at least one end adapted for threaded connection to an adjacent tool string component. The end comprises at least one shoulder adapted to abut an adjacent shoulder of an adjacent end of the adjacent tool string component. An annular magnetic coupler is disposed within an annular recess formed in the at least one shoulder, and the magnetic coupler comprises a coil in electrical communication with an electrical conductor that is in electrical communication with an electronic device secured to the tubular body. The coil comprises a plurality of windings of wire strands that are electrically isolated from one another and which are disposed in an annular trough of magnetic material secured within the annular recess.

The coil wire may comprise a gauge of between 36 and 40 AWG, and may comprise between 1 and 15 coil turns. The coil wire may comprise between 5 and 40 wire strands. The wire strands may be interwoven. The coil may comprise the characteristic of increasing less than 35° Celsius when 160 watts are passed through the coil. In some embodiments the coil may comprise the characteristic of increasing less than 20° C. when 160 watts are passed through the coil.

The adjacent shoulder of the adjacent downhole tool string may comprise an adjacent magnetic coupler configured similar to the magnetic coupler. These couplers may be adapted to couple together when the downhole components are connected together at their ends. The magnetic coupler and the adjacent magnetic coupler may then be adapted to induce magnetic fields in each other when their coils are electrically energized. In such embodiments the magnetic coupler may comprise a characteristic of transferring at least 85% energy from the magnetic coupler to the adjacent magnetic coupler when 160 watts are passed through the coil.

The electronic device that is secured to the tubular body may be a power source. The power source may comprise a battery, generator, capacitor, motor, or combinations thereof. In some embodiments the electronic device may be a sensor, drill instrument, logging-while-drilling tool, measuring-while-drilling tool, computational board, or combinations thereof.

The magnetic material may comprise a material selected from the group consisting of ferrite, a nickel alloy, a zinc alloy, a manganese alloy, soft iron, a silicon iron alloy, a cobalt iron alloy, a mu-metal, a laminated mu-metal, barium, strontium, carbonate, samarium, cobalt, neodymium, boron, a metal oxide, rare earth metals, and combinations thereof. The magnetic material may comprise a relative magnetic permeability of between 100 and 20000.

In another aspect of the invention, a method of transferring power from a downhole tool string component to an adjacent tool string component comprises a step of providing a downhole tool string component and an adjacent tool string component. The components respectively comprise an annular magnetic coupler and an adjacent annular magnetic coupler disposed in an annular recess in a shoulder of an end of the component. The method further comprises adapting the shoulders of the downhole tool string component and the adjacent tool string component to abut one another when the ends of the components are mechanically connected to one another. The method also comprises a step of mechanically connecting the ends of the components to one another and a step of driving an alternating electrical current through the magnetic coupler at a frequency of between 10 and 100 kHz. In some embodiments the frequency may be between 50 and 79 kHz. In some embodiments a square wave may be used. The square wave may be a 170-190 volt square wave.

The magnetic coupler and the adjacent magnetic coupler may be respectively disposed within annular troughs of magnetic material that are disposed within the respective annular recess of the downhole and adjacent components. At least one of the magnetic coupler and adjacent magnetic coupler may comprise a coil that comprises a plurality of windings of wire strands, the wire strands each being electrically isolated from one another. At least 85% of the energy comprised by the alternating electrical current being driven through the annular magnetic coupler may be inductively transferred to the adjacent magnetic coupler when 160 watts are passed through the coil. In some embodiments at least 95% of the energy comprised by the alternating electrical current being driven through the annular magnetic coupler may be inductively transferred to the adjacent magnetic coupler when 160 watts are passed through the coil.

### BRIEF DESCRIPTION OF THE DRAWINGS

FIG. 1 is a cross-sectional view of a formation disclosing an orthogonal view of a tool string.

FIG. 2 is a cross-sectional diagram of an embodiment of tool string component.

FIG. 3 is a cross-sectional diagram of another embodiment of a tool string component.

FIG. 3a is an electrical schematic of an embodiment of an electrical circuit.

FIG. 4 is a perspective diagram of an embodiment of a magnetic coupler.

FIG. 5 is an exploded diagram of an embodiment of a magnetic coupler.

FIG. 6 is a cross-sectional diagram of an embodiment of a magnetic coupler disposed in a tool string component.

FIG. 7 is a perspective diagram of an embodiment of a coil comprising a plurality of electrically isolated wire strands.

FIG. 8 is a perspective diagram of another embodiment of a coil comprising a plurality of electrically isolated wire strands.

FIG. 9 is a cross-sectional diagram of a tool string component comprising an embodiment of an electronic device.

FIG. 10 is a perspective diagram of an embodiment of a magnetic coupler

FIG. 11 is a cross-sectional diagram of an embodiment of a tool string component connected to an adjacent tool string component.

FIG. 12 is a cross-sectional diagram of a formation comprising a tool string having a downhole network.

FIG. 13 is a cross-sectional diagram of an embodiment of a tool string component comprising an embodiment of an electronic device.

FIG. 14 is a flowchart disclosing an embodiment of a method of transferring power between tool string components.

### DETAILED DESCRIPTION OF THE INVENTION AND THE PREFERRED EMBODIMENT

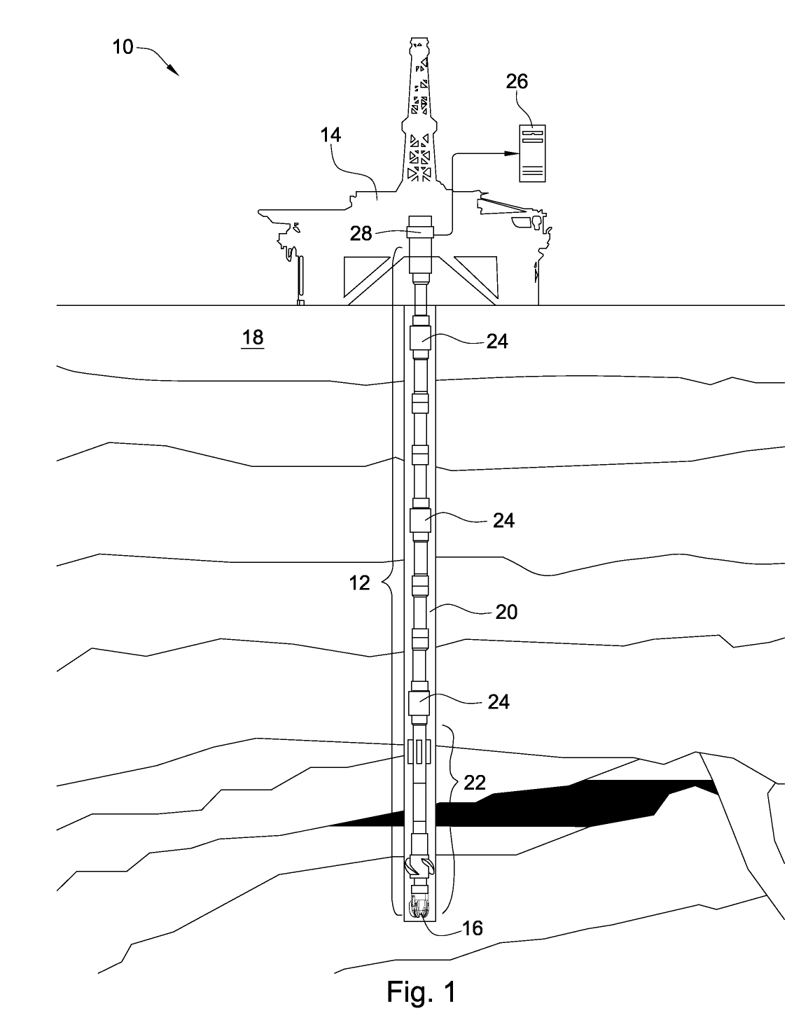

Referring to FIG. 1, one embodiment of a downhole drilling system 10 for use with the present invention includes a tool string 12 having multiple sections of drill pipe and other downhole tools. The tool string 12 is typically rotated by a drill rig 14 to turn a drill bit 16 that is loaded against a formation 18 to form a borehole 20. Rotation of the drill bit 16 may alternatively be provided by other downhole tools such as drill motors or drill turbines located adjacent to the drill bit 16.

The tool string 12 includes a bottom-hole assembly 22 which may include the drill bit 16 as well as sensors and other downhole tools such as logging-while-drilling (“LWD”) tools, measurement-while-drilling (“MWD”) tools, diagnostic-while-drilling (“DWD”) tools, or the like. The bottom-hole assembly 22 may also include other downhole tools such as heavyweight drill pipe, drill collar, crossovers, mud motors, directional drilling equipment, stabilizers, hole openers, sub-assemblies, under-reamers, drilling jars, drilling shock absorbers, and other specialized devices.

While drilling, a drilling fluid is typically supplied under pressure at the drill rig 14 through the tool string 12. The drilling fluid typically flows downhole through the central bore of the tool string 12 and then returns up-hole to the drill rig 14 through the annulus 20. Pressurized drilling fluid is circulated around the drill bit 16 to provide a flushing action to carry cuttings to the surface.

To transmit information at high speeds along the tool string 12, a telemetry network comprising multiple network nodes 24 may be integrated into the tool string 12. These network nodes 24 may be used as repeaters to boost a data signal at regular intervals as the signal travels along the tool string 12. The nodes 24 may also be used to interface with various types of sensors to provide points for data collection along the tool string 12. The telemetry network may include a top-hole server 26, also acting as a network node, which may interface with the tool string 12 using a swivel device 28 for transmitting data between the tool string 12 and the server 26. The top-hole server 26 may be used to transfer data and tool commands to and from multiple local and remote users in real time. To transmit data between each of the nodes 24 and the server 26, data couplers and high-speed data cable may be incorporated into the drill pipe and other downhole tools making up the tool string 12. In selected embodiments, the data couplers may be used to transmit data across the tool joint interfaces by induction and without requiring direct electrical contact between the couplers.

One embodiment of a downhole telemetry network is described in U.S. Pat. No. 6,670,880 entitled Downhole Data Transmission System, having common inventors with the present invention, which this specification incorporates by reference. The telemetry network described in the above-named application enables high-speed bi-directional data transmission along the tool string 12 in real-time. This provides various benefits including but not limited to the ability to control downhole equipment, such as rotary steerable systems, instantaneously from the surface. The network also enables transmission of full seismic waveforms and logging-while-drilling images to the surface in real time and communication with complex logging tools integrated into the tool string 12 without the need for wireline cables. The network further enables control of downhole tools with precision and in real time, access to downhole data even during loss of circulation events, and monitoring of pressure conditions, hole stability, solids movement, and influx migration in real time. The use of the abovementioned equipment may require the ability of passing power between segments of the tool string 12.

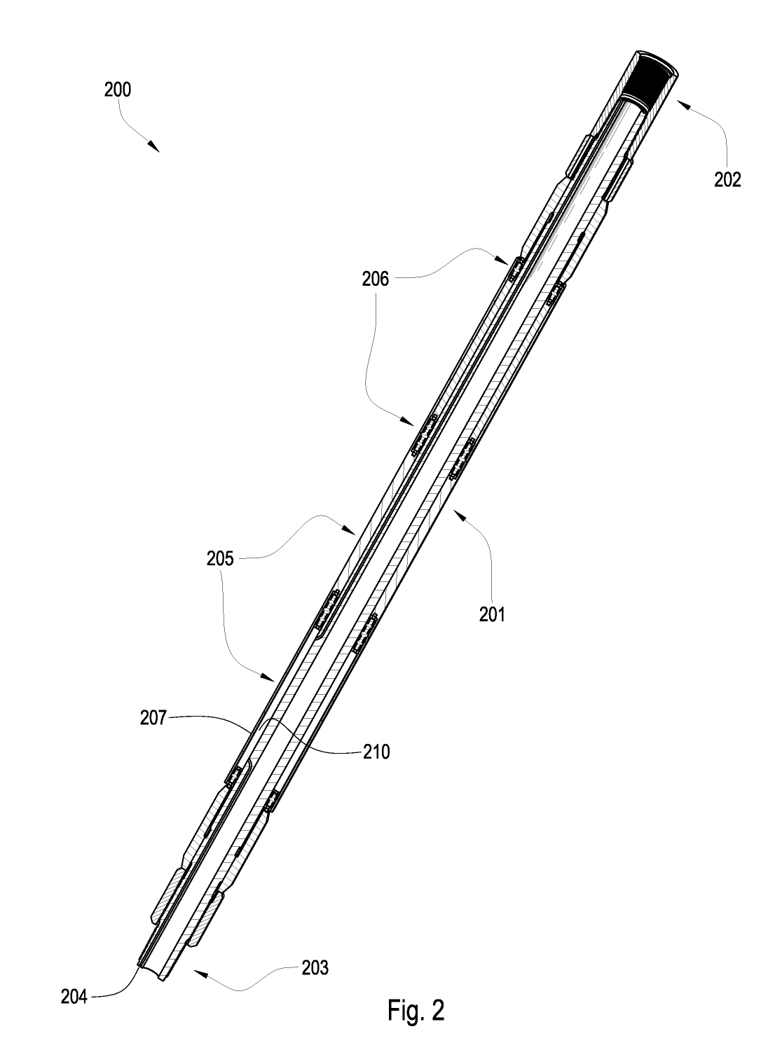

Referring now to FIG. 2, a downhole tool string component 200 in the tool string 12 comprises a tubular body 201 with a box end 202 and a pin end 203, each end 202, 203 being adapted for threaded connection to an adjacent tool string component. Both ends 202, 203 comprise a shoulder 204 that is adapted to abut an adjacent shoulder of an adjacent end of an adjacent tool string component. The component 200 may comprise a plurality of pockets 205. The pockets 205 may be formed by a plurality of flanges 206 disposed around the component 200 at different axial locations and covered by individual sleeves 207 disposed between and around the flanges 206. A pocket 205 may be formed around an outer diameter of the tubular body 201 by a sleeve 207 disposed around the tubular body 201 such that opposite ends of the sleeve 207 fit around at least a portion of a first flange and a second flange. The sleeves 207 may be interlocked or keyed together near the flanges for extra torsional support. At least one sleeve 207 may be made of a non-magnetic material, which may be useful in embodiments using magnetic sensors or other electronics. The pockets 205 may be sealed by a sleeve 207.

Electronic equipment may be disposed within at least one of the pockets 205 of the tool string component. The electronics may be in electrical communication with the aforementioned telemetry system, or they may be part of a closed-loop system downhole. An electronic device 210 is secured to the tubular body 201 and may be disposed within at least one of the pockets 205, which may protect the device 210 from downhole conditions. The electronic device may comprise sensors for monitoring downhole conditions. The sensors may include pressure sensors, strain sensors, flow sensors, acoustic sensors, temperature sensors, torque sensors, position sensors, vibration sensors, geophones, hydrophones, electrical potential sensors, nuclear sensors, or any combination thereof. In some embodiments of the invention the electronic device may be a sensor, drill instrument, logging-while drilling tool, measuring-while drilling too, computational board, or combinations thereof. Information gathered from the sensors may be used either by an operator at the surface or by the closed-loop system downhole for modifications during the drilling process. If electronics are disposed in more than one pocket, the pockets may be in electrical communication, which may be through an electrically conductive conduit disposed within the flange separating them. The information may be sent directly to the surface without any computations taking place downhole. In some embodiments the electronic device may be a sonic tool. The sonic tool may comprise multiple poles and may be integrated directly into the tool string. Sending all of the gathered information from the sonic tool directly to the surface without downhole computations may eliminate the need for downhole electronics which may be expensive. The surface equipment may in some cases by able to process the data quicker since the electronics up-hole is not being processed in a high temperature, high pressure environment.

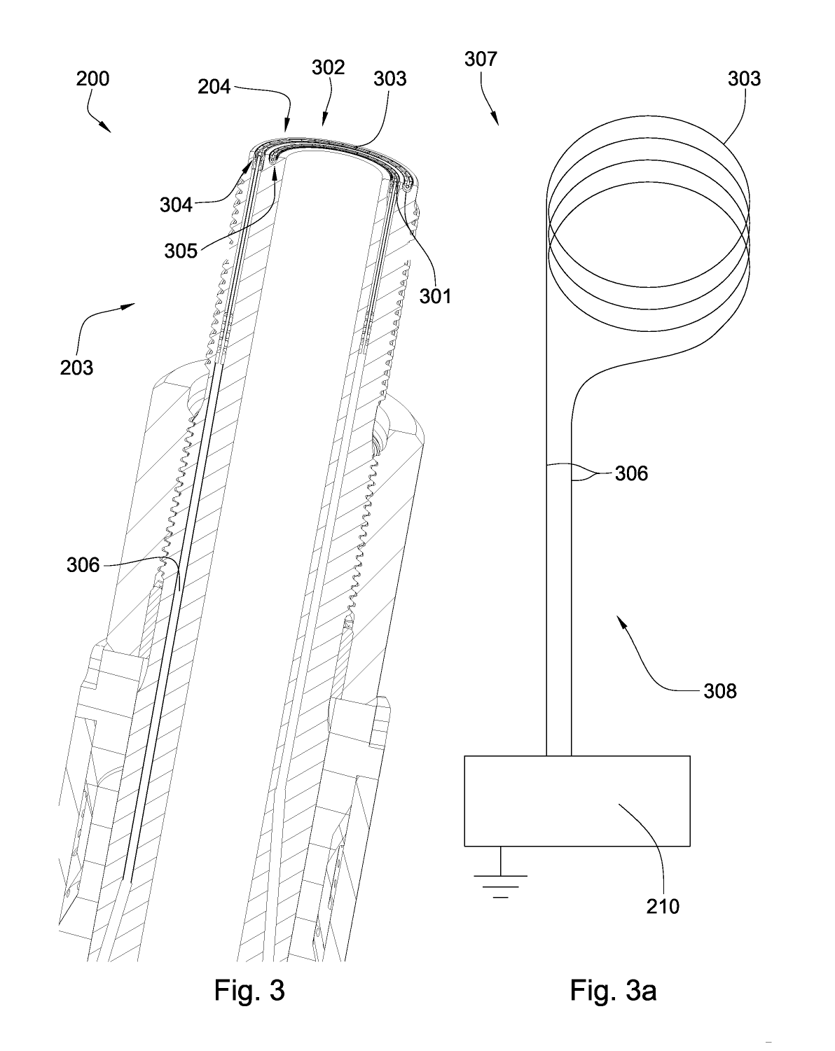

Referring now to FIG. 3 and FIG. 3a, FIG. 3 discloses a pin end 203 of the component 200 comprising a plurality of annular recesses 301 formed in the shoulder 204. In some embodiments the shoulder 204 may comprise a single recess 301. An annular magnetic coupler 302 is disposed within each recess 301 and comprises a coil 303. A first coupler 304 may be optimized for the transfer of power and a second coupler 305 may be optimized for the transfer of data. Referring to the coil 303 disposed in the first coupler 304, the coil 303 is in electrical communication with the electronic device 210 via an electrical conductor 306. An electrical circuit 307 comprises the electronic device 210, the annular coil 303 disposed in the first coupler 304, and two electrical conductors 306 that are disposed intermediate the electronic device 210 and the coil 303 and which are in electrical communication with both the electronic device 210 and the coil 303. A portion 308 of the electrical circuit 307 comprises the coil 303 and the two electrical conductors 306, and in some embodiments may not comprise the electronic device 210. The portion 308 is electrically isolated from the tubular body 201 of the component 200.

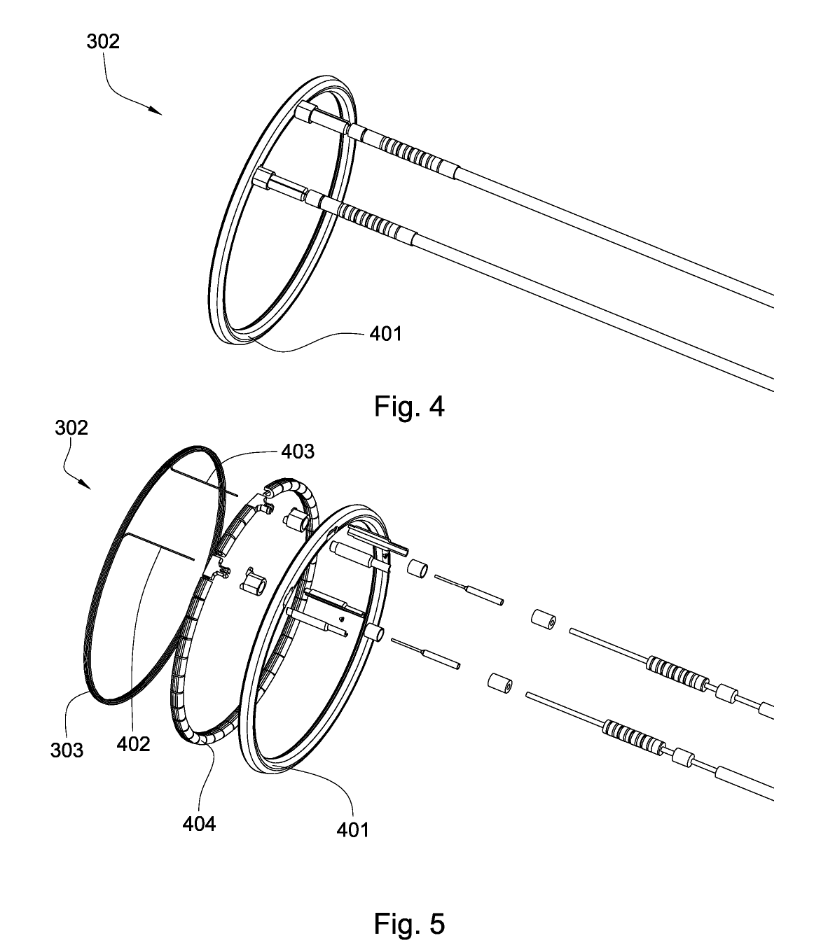

FIGS. 4 and 5 respectively disclose a perspective view and an exploded view of an embodiment of a magnetic coupler 302. The coupler comprises a housing ring 401, a first lead 402 and a second lead 403. The housing ring 401 may comprise a durable material such as steel. In the present embodiment the first and second leads 403 are proximate one another. The leads 402, 403 are adapted to electrically communicate with the two electrical conductors 306 disclosed in FIG. 3. In the embodiments of FIGS. 4 and 5, the leads 402, 403 and their corresponding electrical conductors 306 are disposed proximate one another. The magnetic coupler 302 also comprises a coil 303 and an annular trough 404 made of magnetic material. The magnetic material may comprise a composition selected from the group consisting of ferrite, a nickel alloy, a zinc alloy, a manganese alloy, soft iron, a silicon iron alloy, a cobalt iron alloy, a mu-metal, a laminated mu-metal, barium, strongtium, carbonate, samarium, cobalt, neodymium, boron, a metal oxide, rare earth metals, Fe, Cu, Mo, Cr, V, C, Si, molypermalloys, metallic powder suspended in an electrically insulating material, and combinations thereof. The magnetic material may comprise a relative magnetic permeability of between 100 and 20000. The coil 303 may comprise an electrically conductive material such as copper. When an alternating electrical current is passed through the coil 303 an inductive signal may be generated. The coil 303 may comprise a characteristic of increasing less than 35 degrees Celsius (° C.) when 160 watts of power are passed through the coil 303. In some embodiments the coil 303 may increase less than 20° C. when 160 watts are passed through it.

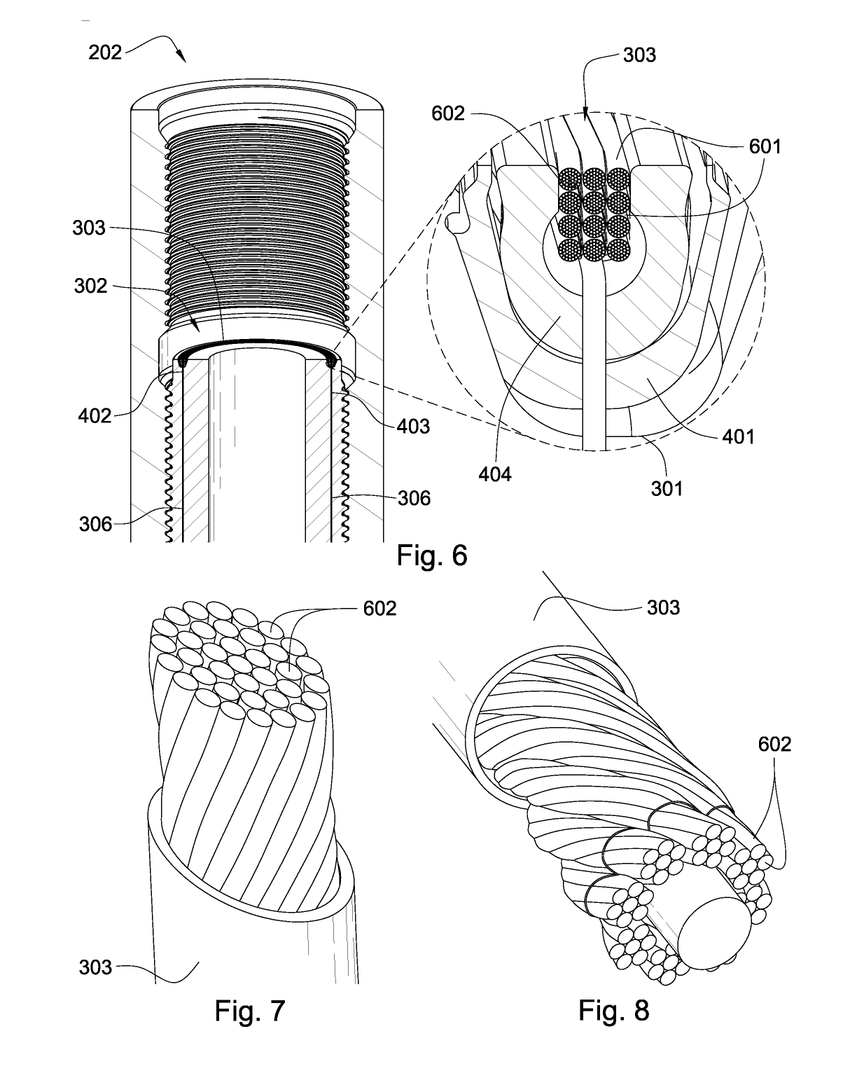

Referring now to FIGS. 6-8, the magnetic coupler 302 comprises a coil 303 having a plurality of windings 601 of wire strands 602 that are each electrically isolated from one another. The wire strands 602 are disposed in the annular trough 404 of magnetic material that is secured within the annular recess 301. As disclosed in FIGS. 7 and 8, the wire strands 602 may be interwoven. In some embodiments each coil 303 may comprise between 5 and 40 wire strands 602 and between 1 and 15 coil turns. In the present application, windings 601 and coil turns may be used interchangeably. The coil 303 may comprise a gauge between 36 and 40 AWG. In the present embodiment the leads 402, 403 of the magnetic coupler 302 and their corresponding electrical conductors 306 are disposed on opposite sides of the magnetic coupler 302. In some embodiments, the strands are collectively wrapped with an insulator and in some embodiments, the no insulator is required. A filler material such as Teflon® or an epoxy may be used to fill the gaps in the couplers, such as the gaps between the coil and the trough, and the trough and the recess, and so forth.

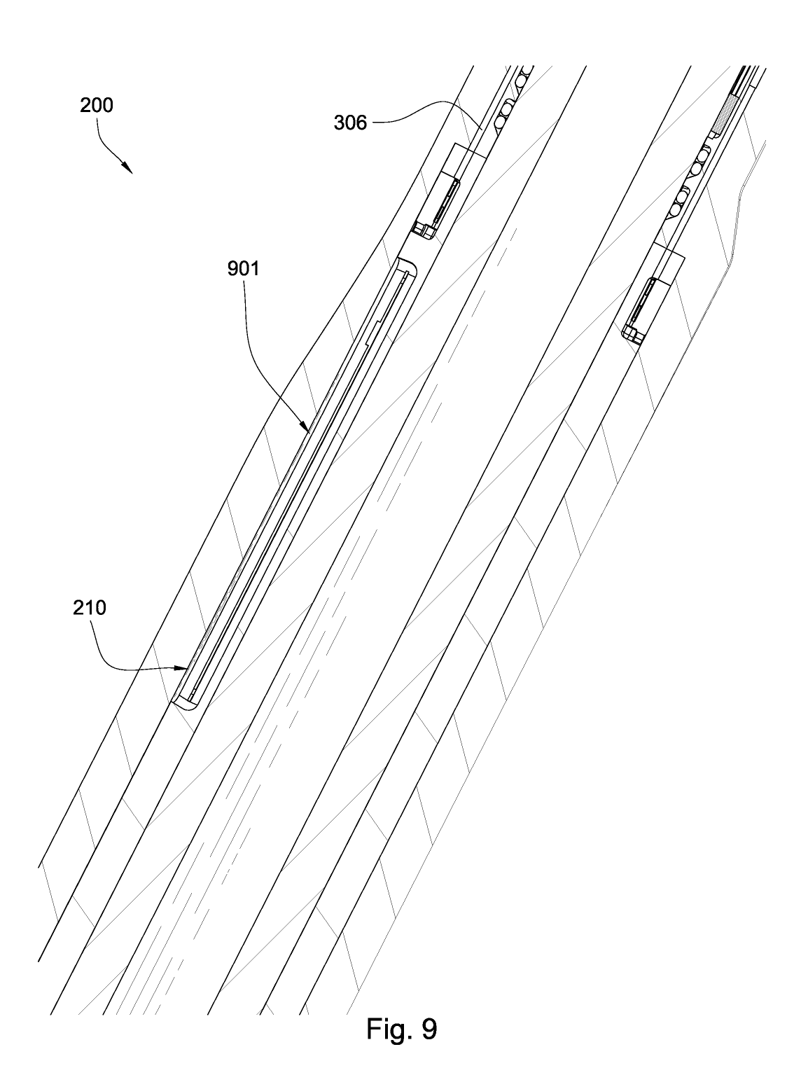

FIG. 9 discloses an embodiment of a component 200 in which the electronic device 210 is a computational board 901. The computational board is in electrical communication with both the first and second leads 402, 403 of the magnetic coupler 302 through the electrical conductor 306. The computational board 901 may send and receive electrical signals to and from other electrical equipment associated with the drilling operation through the downhole network.

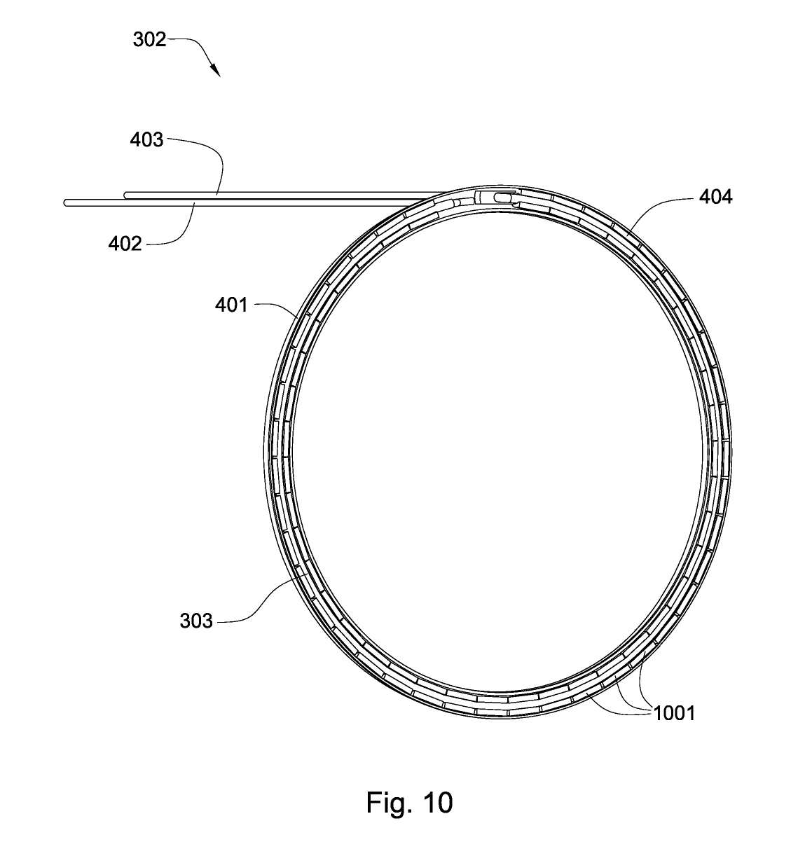

FIG. 10 is an perspective diagram of a magnetic coupler 302 in which the first and second leads 402, 403 are proximate one another. FIG. 10 also discloses an embodiment in which the annular trough 404 of magnetic material comprises a plurality of segments 1001 of magnetic material that are each disposed intermediate the coil 303 and the ring housing 401.

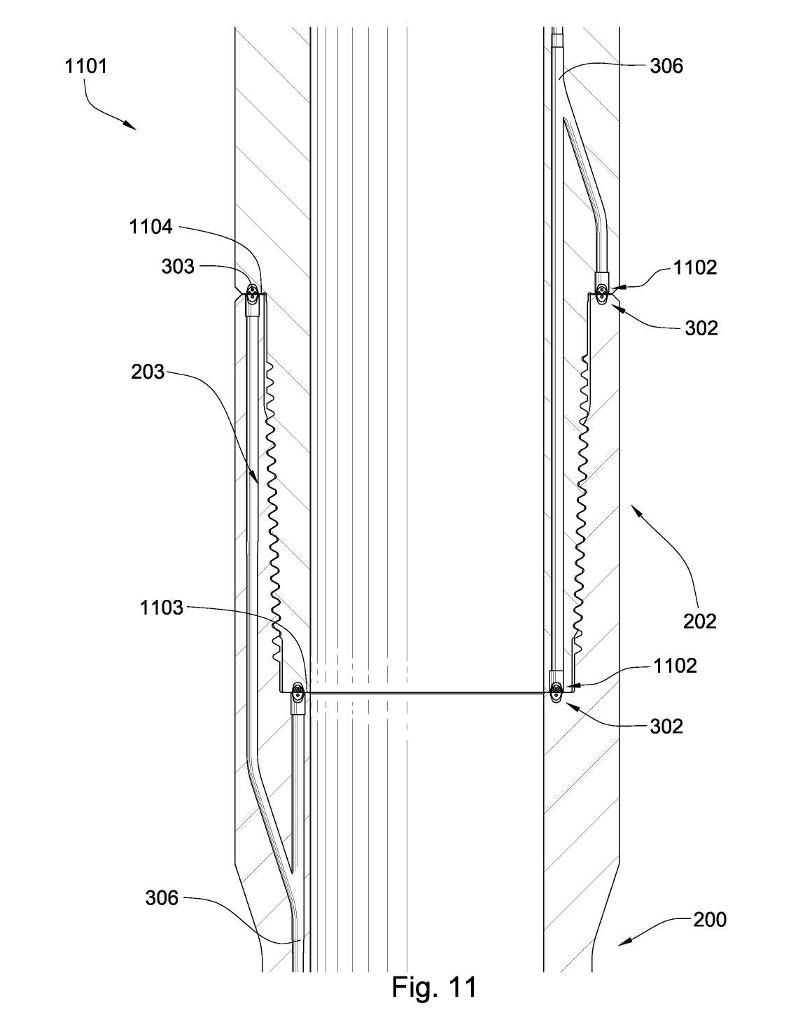

Referring now to FIG. 11, an embodiment is disclosed in which the downhole component 200 is connected at its box end 202 to the pin end 203 of an adjacent tool string component 1101. The adjacent component 1101 comprises an adjacent magnetic coupler 1102 that is configured similar to the magnetic coupler 302 of the downhole component 200. The couplers 302, 1102 are adapted to couple when the components 200, 1101 are connected together at their ends 202, 203. The couplers 302, 1102 are adapted to induce magnetic fields in each other when their coils 303 are electrically energized. Specifically, passing an alternating electrical current through the coil 303 of either coupler 302, 1102, induces a magnetic field in the other coupler 1102, 302. This induced magnetic field is believed to induce an alternating electrical current in the induced coil. In some embodiments, when 160 watts are passed through one of the couplers 302, 1102, at least 136 watts are induced in other coupler 1102, 302. In other words, the magnetic coupler 302 may comprise a characteristic of transferring at least 85% of its energy input into the adjacent coupler 1102. In some embodiments the magnetic coupler 302 may transfer at least 95% of its input energy into the adjacent coupler 1102.

FIG. 11 also discloses tool string components 200, 1101 comprising both primary and secondary shoulders 1103, 1004. In the present embodiment a magnetic coupler 302 is disposed in each of the primary and secondary shoulders 1103, 1004. In some embodiments only the primary shoulder 1103 or only the secondary shoulder 1104 may comprise a magnetic coupler. In embodiments where each of the primary and secondary shoulders 1103, 1004 comprises a magnetic coupler 302, each coupler 302 may transfer energy at a different optimal frequency. This may be accomplished by providing the first and second coils with different geometries which may differ in number windings 601, diameter, type of material, surface area, length, or combinations thereof. The annular troughs 404 of the couplers 302, 1102 may also comprise different geometries as well. The inductive couplers 302, 1102 may act as band pass filters due to their inherent inductance, capacitance and resistance such that a first frequency is allowed to pass at a first resonant frequency, and a second frequency is allowed to pass at a second resonant frequency. Preferably, the signals transmitting through the electrical conductors 306 may have frequencies at or about at the resonant frequencies of the band pass filters. By configuring the signals to have different frequencies, each at one of the resonant frequencies of the couplers, the signals may be transmitted through one or more tool string components and still be distinguished from one another. In FIG. 11, the coils 303 disposed in the magnetic couplers 302 in the primary and secondary shoulders 1103, 1104 of the tool string component each comprise a single winding 601, while the coils 303 disposed in the adjacent magnetic couplers 1102 in the primary and secondary shoulders 1103, 1004 of the adjacent component 1101 each comprise three windings 601. Other numbers and combinations of windings 601 may be consistent with the present invention.

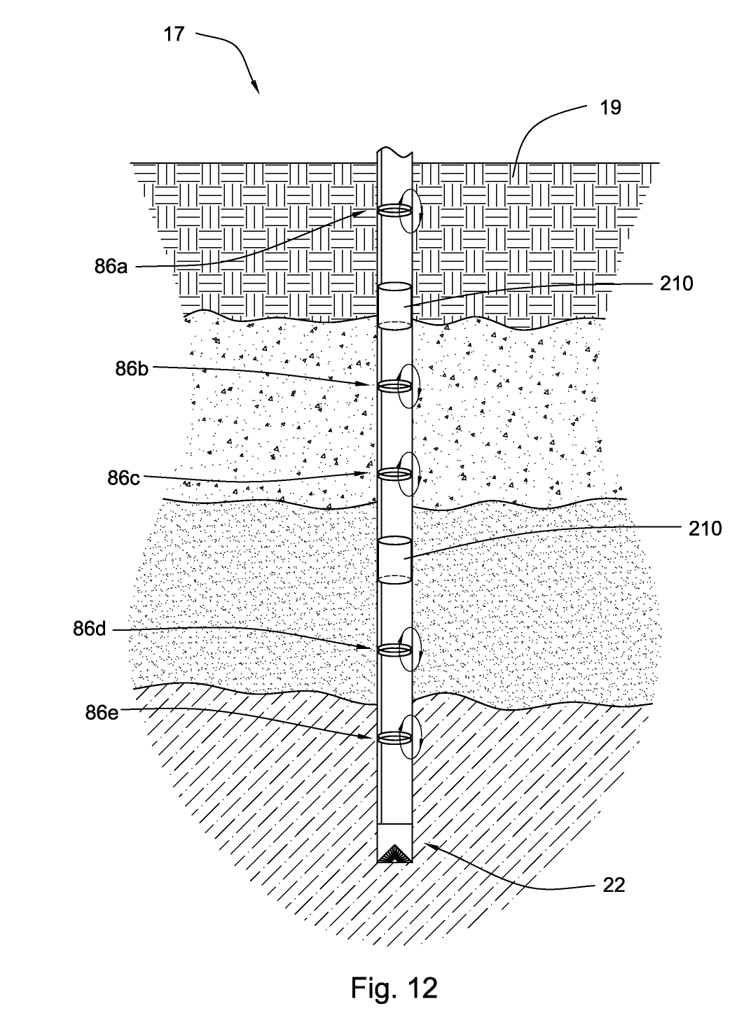

Referring now to FIG. 12, an embodiment of a downhole network 17 in accordance with the invention is disclosed comprising various electronic devices 210 spaced at selected intervals along the network 17. Each of the electronic devices 210 may be in operable communication with a bottom-hole assembly 22 based on power and/or data transfer to the electronic devices 210. As power or data signals travel up and down the network 17, transmission elements 86a-e may be used to transmit signals across tool joints of a tool string 12. Transmission elements 86a-e may comprise a magnetic coupler 302 coupled with an adjacent magnetic coupler 1102. Thus, a direct electrical contact is not needed across a tool joint to provide effective power coupling. In selected embodiments, when using transmission elements 86a-e, consistent spacing should be provided between each transmission element 86a-e to provide consistent impedance or matching across each tool joint. This may help to prevent excessive power loss caused by signal reflections or signal dispersion at the tool joint.

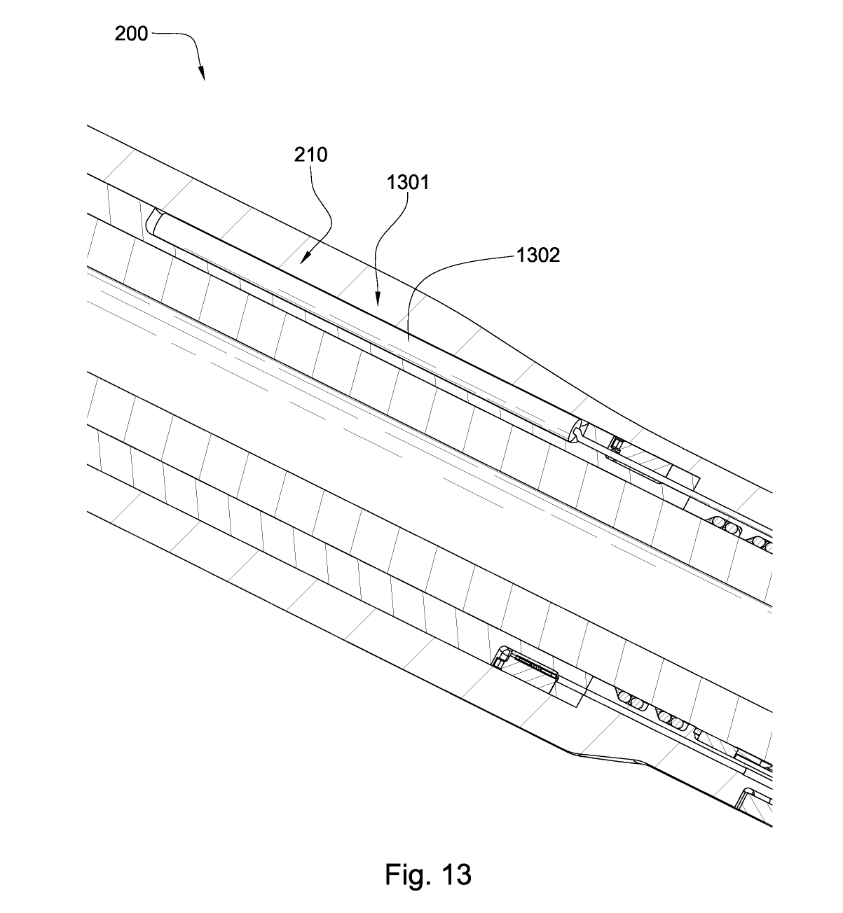

FIG. 13 discloses an embodiment in which the electronic device 210 is a power source 1301. In FIG. 13 the power source 1301 is a battery 1302. The battery 1302 may store chemical potential energy within it. Because downhole sensors, tools, telemetry and other electronic components require power to operate, a need exists for a reliable energy source to power downhole components. In some embodiments, the power source 1301 may comprise a battery, generator, capacitor, motor, or combinations thereof. A downhole electric power generator may be used to provide power to downhole components. In certain embodiments, the generator may be a micro-generator mounted in the wall of a downhole tool to avoid obstructing the tool's central bore.

In general, a downhole generator in accordance with the invention may include a turbine mechanically coupled to an electrical generator. The turbine may receive a moving downhole fluid, such as drilling mud. This downhole fluid may turn blades of the turbine to produce rotational energy (e.g., by rotating a shaft, etc.). This rotational energy may be used to drive a generator to produce electricity. The electrical power produced by the generator may be used to power electrical equipment such as sensors, tools, telemetry components, and other electronic components. One example of a downhole generator which may be used with the present invention is described in U.S. Pat. No. 7,190,084 which is herein incorporated by reference in its entirety. Preferably, however, the turbine is disposed within the bore of the drill string.

Downhole generators may be AC generators that are configured to produce an alternating current with a frequency between about 100 Hz and 2 kHz. More typically, AC generators are configured to produce an alternating current with a frequency between about 300 Hz and 1 kHz. The frequency of the alternating current is proportional to the rotational velocity of the turbine and generator. In some embodiments of the invention, a frequency converter may alter the frequency from a range between 300 Hz and 1 kHz to a range between 10 kHz and 100 kHz. In certain embodiments, an alternating current with a frequency between about 10 kHz and 100 kHz may achieve more efficient power transmission across the tool joints. Thus, in selected embodiments, the frequency of the alternating current produced by the generator may be shifted to a higher frequency to achieve more efficient power transmission.

To achieve this, a rectifier may be used to convert the alternating current of the generator to direct current. An inverter may convert the direct current to an alternating current having a frequency between about 10 kHz and 100 kHz. The inverter may need to be a custom design since there may be few if any commercially available inverters designed to produce an AC signal between about 400 Hz and 1 MHz. The alternating current at the higher frequency may then be transmitted through electrical conductors 306 routed along the tool string 12. The power signal may be transmitted across tool joints to other downhole tools by way of the transmission elements 86 discussed in the description of FIG. 12.

In selected embodiments, a gear assembly may be provided between the turbine and the generator to increase the rotational speed of the generator relative to the turbine. For example, the gear assembly may be designed such that the generator rotates between about 1.5 and 10 times faster than the turbine. Such an increase in velocity may be used to increase the power generated by the generator as well as increase the frequency of the alternating current produced by the generator. One example of an axially mounted downhole generator that may be used with the present invention is described in patent application Ser. No. 11/611,310 and entitled System for steering a tool string, which has common inventors with the present invention and which this specification incorporates by reference for all that it contains.

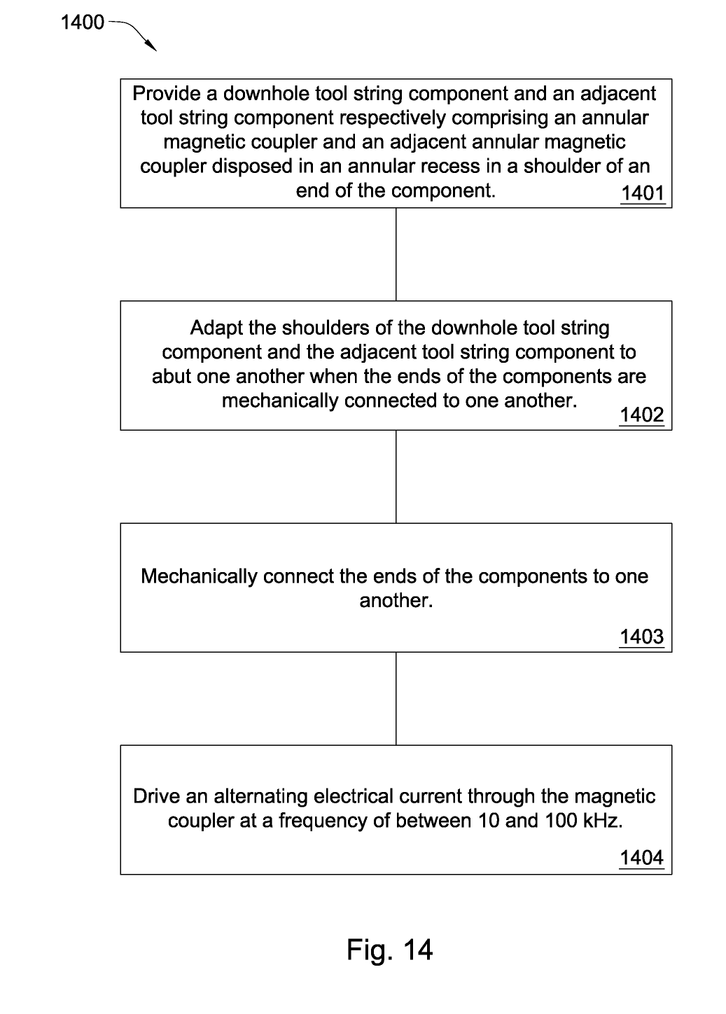

Referring now to FIG. 14, a flowchart illustrates a method 1400 of transferring power from a downhole tool string component 200 to an adjacent tool string component 1101. The method 1400 comprises a step 1401 of providing a downhole tool string component 200 and an adjacent tool string component 1101 respectively comprising an annular magnetic coupler 302 and an adjacent annular magnetic coupler 1102. Each coupler 302, 1102 is disposed in an annular recess 301 in a shoulder 204 of an end 202, 203 of one of the components 200, 1101. The method 1400 further comprises a step 1402 of adapting the shoulder 204 of each of the downhole tool string component 200 and the adjacent tool string component 1101 to abut one another when the ends 202, 203 of the components 200, 1101 are mechanically connected to one another. The method 140 further comprises a step 1403 of mechanically connecting the ends 202, 203 of the components 200, 1101 to one another, and a step 1404 of driving an alternating electrical current through the magnetic coupler 302 at a frequency of between 10 and 100 kHz. In some embodiments, the alternating electrical current is a square wave.

In some embodiments the alternating electrical current may be driven at a frequency between 50 and 70 kHz. The magnetic couplers 302, 1102 may each be disposed within an annular trough 404 of magnetic material. The troughs 404 may each be disposed within an annular recess 301 of the tool string components 200, 1101. At least one of the magnetic couplers 302, 1102 may comprise a coil 303 that comprises a plurality of windings 601 of wire strands 602. The wire strands 602 may each be electrically isolated from each other. In some embodiments at least 85% of the energy comprised by the alternating electrical current being driven through the annular magnetic coupler 302 may be inductively transferred to the adjacent magnetic coupler 1102 when 160 watts are passed through the coil 303 of the magnetic coupler 302. In some embodiments at least 95% of the energy may be inductively transferred when 160 watts are passed through the coil 303.

Whereas the present invention has been described in particular relation to the drawings attached hereto, it should be understood that other and further modifications apart from those shown or suggested herein, may be made within the scope and spirit of the present invention.

What is claimed is:

1. A downhole tool string component, comprising:
a tubular body with at least one end adapted for threaded connection to an adjacent tool string component;
the end comprising at least one shoulder adapted to abut an adjacent shoulder of an adjacent end of the adjacent tool string component;
an annular magnetic coupler disposed within an annular recess formed in the at least one shoulder;
the magnetic coupler comprises a coil in electrical communication with an electrical conductor in electrical communication with an electronic device secured to the tubular body; and
the coil comprises a plurality of windings of wire strands that are electrically isolated from one another and disposed in an annular trough of magnetic material secured within the annular recess.

2. The component of claim 1, wherein the wire strands are interwoven.

3. The component of claim 1, wherein the coil comprises the characteristic of increasing less than 35° C. when 160 watts are passed through the coil.

4. The component of claim 1, wherein the coil comprises the characteristic of increasing less than 20° C. when 160 watts are passed through the coil.

5. The component of claim 1, wherein the adjacent shoulder of the adjacent downhole tool string comprises an adjacent magnetic coupler configured similar to the magnetic coupler and these couplers are adapted to couple when the downhole components are connected together at their ends, wherein the magnetic coupler and the adjacent magnetic coupler are adapted to induce magnetic fields in each other when their coils are electrically energized.

6. The component of claim 5, wherein the magnetic coupler comprises a characteristic of transferring at least 85% energy from the magnetic coupler to the adjacent magnetic coupler when 160 watts are passed through the coil.

7. The component of claim 1, wherein the electronic device is a power source.

8. The component of claim 7, wherein the power source comprises a battery, generator, capacitor, motor, or combinations thereof.

9. The component of claim 1, wherein the electronic device is a sensor, drill instrument, logging-while-drilling tool, measuring-while-drilling tool, computational board, or combinations thereof

10. The component of claim 1, wherein the magnetic material comprises a material selected from the group consisting of ferrite, a nickel alloy, a zinc alloy, a manganese alloy, soft iron, a silicon iron alloy, a cobalt iron alloy, a mu-metal, a laminated mu-metal, barium, strontium, carbonate, samarium, cobalt, neodymium, boron, a metal oxide, rare earth metals, and combinations thereof.

11. The component of claim 1, wherein the magnetic material comprises a relative magnetic permeability of between 100 and 20000

12. The component of claim 1, where in the coil comprises between 5 and 30 wire strands.

13. The component of claim 1, wherein the coil comprises a gauge between 36 and 40 AWG.

14. The component of claim 1, wherein the coil comprises between 1 and 15 coil turns.

15. A method of transferring power from a downhole tool string component to an adjacent tool string component, comprising:
providing a downhole tool string component and an adjacent tool string component respectively comprising an annular magnetic coupler and an adjacent annular magnetic coupler disposed in an annular recess in a shoulder of an end of the component;
adapting the shoulders of the downhole tool string component and the adjacent tool string component to abut one another when the ends of the components are mechanically connected to one another;
mechanically connecting the ends of the components to one another;
driving an alternating electrical current through the magnetic coupler at a frequency of between 10 and 100 kHz.

16. The method of claim 15, wherein the frequency is between 50 and 70 kHz.

17. The method of claim 15, wherein the magnetic coupler and the adjacent magnetic coupler are respectively disposed within annular troughs of magnetic material that are disposed within the respective annular recess of the downhole and adjacent components.

18. The method of claim 15, wherein at least one of the magnetic coupler and adjacent magnetic coupler comprise a coil that comprises a plurality of windings of wire strands, the wire strands each being electrically isolated from one another.

19. The method of claim 18, wherein at least 85% of energy comprised by the alternating electrical current being driven through the annular magnetic coupler is inductively transferred to the adjacent magnetic coupler when 160 watts are passed through the coil.

20. The method of claim 18, wherein at least 95% of energy comprised by the alternating electrical current being driven through the annular magnetic coupler is inductively transferred to the adjacent magnetic coupler when 160 watts are passed through the coil.

21. The method of claim 15, wherein the alternating electrical current is a square wave.
